(19) United States
(12) Patent Application Publication
(10) Pub. No.: US 2004/0206871 A1
(43) Pub. Date: Oct. 21, 2004

(54) Assembly of sectors of a dispensing unit a in a gas turbine

(76) Inventors: Sebastien Imbourg, Yerres (FR); Philippe Pabion, Vaux le Peril (FR); Jean-Luc Soupizon, Vaux Le Penil (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/487,729

(22) PCT Filed: Sep. 11, 2002
(86) PCT No.: PCT/FR02/03091

(30) Foreign Application Priority Data
Sep. 13, 2001 (FR) 0111830

(51) Int. Cl. F16B 45/00

(52) U.S. Cl. 248/304

(57) ABSTRACT

An assembly of turbine distributor sectors in a casing. Retaining hooks of a flange of straightening sectors, bearing fixed blades in a turbomachine, are advantageously placed on an end plate distinct from the casing but assembled on the casing. In this way, these hooks no longer constitute weak points in the casing, as if they were all in one piece with it, assembly of the sectors is facilitated, and the assembly is more rigid.

The present invention relates to assembling distributor sectors, bearing fixed blades, ensuring correction of gas flow in a turbomachine, in a casing, which encloses the stator of this machine.

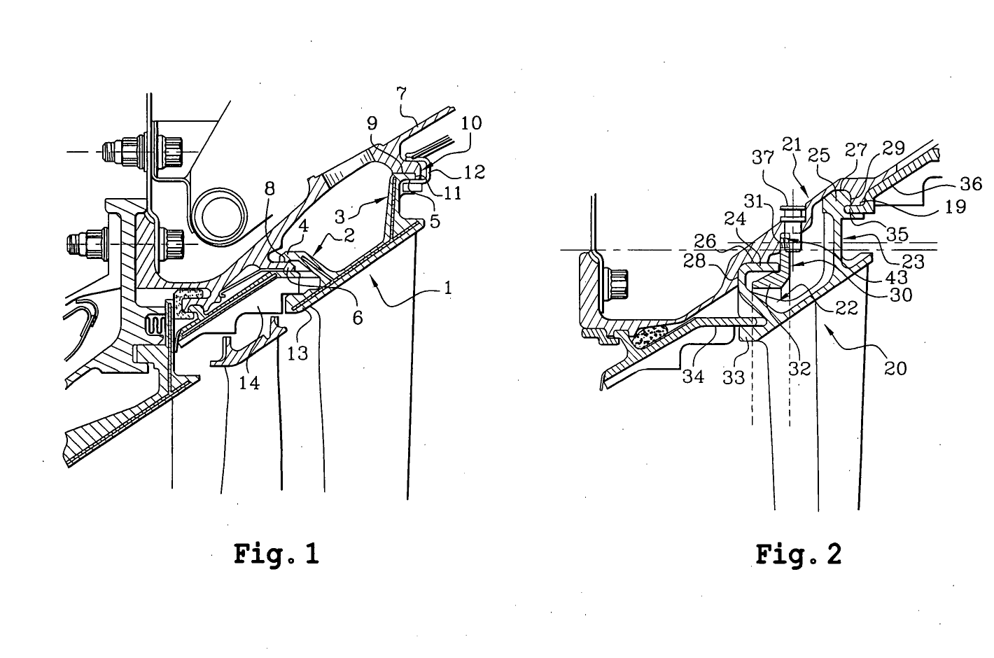

The external stream of gases from the turbomachines is delimited by the distributor sectors and ferrule sectors which alternate along the machine, and which are mounted between one another and on the casing mainly via overlapping of hooks. With reference to FIG. 1, which illustrates an already known assembly, a straightening sector 1 bears a pair of assembly flanges 2 and 3, respectively at the front and at the rear, and which are both fitted with end hooks 4 and 5, extending in the longitudinal direction of the machine. The end hook 4 at the front is placed on a hook 6 of a casing 7 by a pair of mutual support faces 8, which hold the sectors 1 against centripetal radial movements in the machine; the end hook 5 of the other flange 3 abuts radially towards the outside against the casing 7 by a pair of faces 9, and towards the rear, against a second hook 10 of the casing 7, by a pair of flat stop faces 11. A clip 12 is placed around the second hook 10 as far as below the second end hook 5 to also guard the sectors 1 against centripetal movements. The sectors 7 comprise more projections 13 towards the front, which encircle the rear of ferrule segments 14 between them and the first hooks.

This assembly holds the sectors 1 against the movements produced by the radial and axial forces oriented towards the rear, which they undergo during operation. Mounting is not very convenient to carry out, as the inclined sectors 1 have to be in the casing 7 so that the lip 3 at the rear enters the second hook 10 before making them pivot about the end hook 4 at the front, so that the end hook 5 enters behind the hooks 10 with a radial movement towards the outside. To effect this assembly it is necessary to have two major sets of rotor-stator in the internal stream, detrimental to the seals between rotor and stator. Finally, probably the most serious disadvantage of this assembly comes from the very existence of hooks 6 and 10 all in one piece with the casing 7, which are subjected to significant mechanical and thermal stresses, since they are near the stream of hot gases. It is necessary to construct them from a sufficiently resistant material, as well as the casing 7 itself, which would not have need for this since it is subjected to a lower temperature; and fatigue cracking can appear in the hooks 6 and 10 and spread to the point where the entire casing 7 needs to be replaced.

It is appropriate to rectify the design of the casing, which is both costly and fragile, while enabling straightening sectors to be mounted more simply, producing a more rigid and less complex assembly. The invention satisfies these various requisites. In its most general form, it relates to assembly of sectors of a distributor ring on a casing, the sectors comprising two flanges fitted with support faces on the casing, a hook coming beneath a curved edge of one of the flanges to support the sectors against centripetal movements, characterised in that it comprises a mobile end plate placed between the flanges, means for fixing the end plate on the casing; the hook is placed on the end plate, the end plate and the casing comprise flat mutual support faces oriented in an axial direction, fixing means comprising slugs passing radially through the casing, the end plate being retained between the casing and the slugs, and the end plate has a mounting direction towards the flange having said curved edge.

The hook, which is the most stressed part of the assembly, can be constructed with much more freedom now that it is on a mobile end plate and thus separated from the casing; it can easily be replaced if required; finally, mounting is effected via linear movement of the sole end plate, more simple than a joint pivoting movement of the sectors.

Assembly is very facile if the hook comprises a conical external face at least on a central portion under the curved edge and tapering towards the flange having said curved edge.

It should be noted that documents U.S. Pat. No. 0,892,497 A and U.S. Pat. No. 568,161 A disclose arrangements where distributor sectors are retained by carriers of a hook which is thus separated from the casing, but the end plates are placed otherwise and are not mounted by translation, but by tilting. They must be divided into sectors: the arrangement and mounting remain complicated.

Other arrangements, which can be adapted in addition to the above, multiply the advantages, which the invention provides. Its various aspects will emerge better from the following description of the figures, in which:

FIG. 1 already described, has the characteristic of an earlier assembly,

FIG. 2 shows the assembly of the invention, and

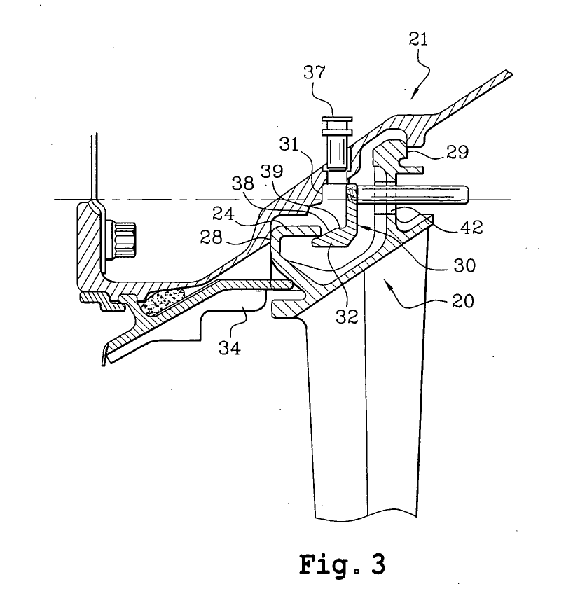

FIG. 3 evokes the mode of assembly.

The casing is now designated by reference numeral 21, but its general form resembles that of the previous one; its diameter decreases towards the front and its form is thus slightly conical at the point of the invention.

The new straightening sectors are designated by reference 20 and comprise, as before, flanges 22 and 23 at the front and at the rear are fitted with end hooks 24 and 25, both curved towards the rear; the end hooks 24 and 25 are here supported on the casing 21 by mutual support faces 26 and 27, oriented in a radial direction, and by flat support faces 28 and 29, oriented in axial and opposite directions. Contrary to the previous design, assembly is much more stable. An essential element of the invention is an end plate 30 also supported on the casing 21 by flat mutual support faces 31, oriented in an axial direction, and which bears on its edge a hook 32 facing the front and passing under the end hook 24 of the first flange 22. The end plate 30 extends on a full turn. As previously, the straightening sectors 20 bear towards the front a projection 33 for retaining the adjacent ferrule sectors 34 underneath. Another projection 35 can be noticed; it is found under the second end hook 25 and its purpose is to support ferrule sectors 35 opposite the preceding.

Slugs 37 are adjusted through the casing 21 in a radial direction, and keep the end plate 30 supported against the casing 21 by engaging behind the latter to block it axially.

The hook 6 of the preceding casing 7 has disappeared, with the hook 32 of the end plate 30 replacing it, such that a weak point of the casing 7 has been eliminated. The hook 10 for the other flange 3 has not disappeared completely, since the second end hook 25 is placed behind a groove 19 of the casing 21, which ensures the same support functions for the flange 23, but it should be emphasised that the groove 19, more massive and less protruding than the hook 10, is much less stressed. Such modification of the hook 10 in the design of FIG. 1 would have been of little use, as long as the hook 6 was there, which had to project substantially to enable the straightening sectors 1 to be mounted by an axial then pivoting movement. In summary, eliminating the weak point of the casing 7 constituted by the hook 6 allows an interest to be taken in eliminating the other weak point constituted by the hook 10.

Eliminating hooks 6 and 10 or replacing them by simpler structures decreases stress and the risk on the casing 21, at the same time simplifying its manufacture. It can be constructed from a material less rich than the casing 7. Only the hook 32 and its end plate 30 remain subjected to major overheating which oblige it to be made of an adapted material.

The straightening sectors 20 rise by a purely radial movement towards the outside (FIG. 3), implying sliding by the pairs of support faces 28 and 29 and which can be created by moving the end plate 30 towards the front as far as the stop of faces 31: the hook 32 is fitted with an external face of which one central surface 38 at least is conical, tapering towards the front, making the first end hook 24 rise onto this surface 38, while the hook 32 advances. When the end hook 24 passes this surface 38 to rest on a rear cylindrical portion 39 of the upper surface of the hook 32, the straightening sectors 20 have been put into place. Then, the slugs 37 are to be introduced to their bores to axially block the end plate 30.

The movement of the end plate 30 towards the front can be made very simply by a special tool, as often found for carrying out assembly and disassembly work of turbomachines: an appropriate tool would comprise a platen mounted in the casing supporting the straightening sectors 1, as well as thrusters for pressing on the rear of the end plate 30 through holes 42 hollowed through the other flange 23.

It should be emphasised that one of the main stresses being exerted on the straightening sectors 1 or 20 is a force to the rear, produced by the flow of air across the latter. This force is translated by a tilting motion around support points of the sectors on the casing 7 or 21 and by a centripetal radial farce on the hook 6 or 32, which makes it vulnerable; but the consequences of breaking would be less serious on the hook 32 than on the hook 6, since it would be enough to replace the end plate 30 instead of the entire casing 7. The hook 32 offers radial support to the inside on sectors 20, just like the hook 6 on the sectors 1, since the end hook 24 is placed on the latter; but it offers more rigid assembly than the hook 6, even though it is not all in one with the casing 21, by keeping the end hook 24 pressed against the casing 21 on the support faces 26; the diameter of the rear portion 39 of its surface can be selected to exert the desired pressing force at this point.

The conicity of the surface 38 always allows the end plate 30 to be placed without difficulty, with the hook 32 playing the part of a corner. Assembly is still stiff, while being simplified, if the ferrule sectors 36 to the rear comprise a projecting front end 43 placed on the projection 35 and introduced on the end hook 25 of the flange 23, in the place of the clip 12.

If the end plate 30 must be replaced, it is easy to extract it if tapping points are put in place, such as internal screw threads 53, which allow it to be gripped by threaded axes introduced through the holes 42, and to be extracted by drawing it to the rear until the straightening sectors 20 are released.

It will have been noticed that the end hook 24 of the first flange 22 was directed to the rear, and the hook 32, with which the first flange is assembled, was directed towards the front, contrary to the traditional arrangement as in FIG. 1. The advantage of this inversion, made possible by eliminating the pivoting movement when mounting the straightening sectors 20, is that the hook 32 and its end plate 30 are lodged between the flanges 22 and 23, in a volume isolated from the temperature of the gases by the distributor sector 20.

1-4. (canceled)

5. Assembly of sectors of a distributor on a casing, the sectors comprising two flanges fitted with support faces on the casing, a hook coming beneath a curved edge of one of the flanges to support the sectors against centripetal movements, the assembly comprising:
a mobile end plate placed between the flanges;
means for fixing the mobile end plate on the casing, wherein the hook is placed on the mobile end plate, and the mobile end plate and the casing comprise flat mutual support faces oriented in an axial direction; and
fixing means comprising slugs passing radially through the casing, the mobile end plate being retained between the casing and the slugs, and wherein the mobile end plate has a mounting direction towards the flange having the curved edge.

6. The assembly of sectors on a casing as claimed in claim 5, wherein the hook comprises a conical external face at least on a central portion under the curved edge and tapering towards the flange having the curved edge

7. The assembly of sectors on a casing as claimed in claim 5, wherein support faces of the flanges on the casing comprise two faces of radial orientation and two faces of opposite axial orientations.

8. The assembly of sectors on a casing as claimed in claim 5, wherein projecting ends of ferrule sectors adjacent to straightening sectors come under a curved edge of other of the flanges, and on projections of the other of the flanges.
